(19) United States
(12) Patent Application Publication
(10) Pub. No.: US 2025/0116796 A1
(43) Pub. Date: Apr. 10, 2025

(54) DATA ASSIMILATION SYSTEM OF NUMERICAL MODEL USING ATMOSPHERIC RESEARCH AIRCRAFT OBSERVATIONAL DATA, METHOD OF CONSTRUCTING WEATHER PREDICTION MODEL WITH DATA ASSIMILATION SYSTEM, AND SYSTEM FOR EVALUATING PERFORMANCE OF WEATHER PREDICTION MODEL WITH DATA ASSIMILATION APPLIED

(71) Applicant: REPUBLIC OF KOREA (NATIONAL INSTITUTE OF METEOROLOGICAL SCIENCES), Seogwipo-si (KR)

(72) Inventors: Seung-Beom Han, Seogwipo-si (KR); Ji Won Hwang, Seogwipo-si (KR); Tae Young Goo, Seogwipo-si (KR); Dong Hyun Cha, Seogwipo-si (KR); Sueng Pil Jung, Seogwipo-si (KR); Min Seong Kim, Seogwipo-si (KR); Deok-Du Kang, Seogwipo-si (KR); Myoung Hun Kang, Seogwipo-si (KR); Kwang Jae Lee, Seogwipo-si (KR); Jong Hoon Shin, Seogwipo-si (KR); Chul Kyu Lee, Seogwipo-si (KR)

(73) Assignee: REPUBLIC OF KOREA (NATIONAL INSTITUTE OF METEOROLOGICAL SCIENCES), Seogwipo-si (KR)

(21) Appl. No.: 18/788,048

(22) Filed: Jul. 29, 2024

(30) Foreign Application Priority Data
Oct. 6, 2023 (KR) 10-2023-0133510

(51) Int. Cl. G01W 1/10; G01W 1/00; G01W 1/18

(52) U.S. Cl. CPC G01W 1/10; G01W 1/18; G01W 2001/003

(57) ABSTRACT

The present disclosure provides a data assimilation system of numerical models using atmospheric research aircraft observation data for constructing a data assimilation system for generating improved initial conditions and performing efficient aerial observation work using atmospheric research aircraft observation data, and a method of constructing a weather prediction model with data assimilation applied of the data assimilation system. A data assimilation system of numerical models using atmospheric research aircraft observation data includes an observation error data generation module, a background error covariance generation module, a data assimilation module and a lateral boundary field generation module.

### CROSS-REFERENCE TO RELATED APPLICATIONS

This application claims the priority of Korean Patent Application No. 10-2023-0133510 filed on Oct. 6, 2023, in the Korean Intellectual Property Office, the disclosure of which is incorporated herein by reference.

### BACKGROUND

### Field

The present disclosure relates to a data assimilation system of numerical models using atmospheric research aircraft observation data that can construct a weather prediction model with data assimilation applied using initial conditions of the numerical models as the atmospheric research aircraft observation data, etc., and evaluate performance of the weather prediction model with data assimilation applied, a method of constructing a weather prediction model with data assimilation applied of the data assimilation system, and a system for evaluating performance of the weather prediction model.

### Description of the Related Art

Data assimilation refers to a process of producing a current atmospheric state by adjusting forecast results (initial conditions, initial input data, etc.) of a numerical model with real observation data. The data assimilation includes a process of creating an analysis field, which is input data of weather forecast. The analysis field is the current atmospheric state and is produced using a background field (data predicting a current time at a previous time), observation data at the current time, and errors of the two data.

In particular, among the input data that creates a first guess of a data assimilation system, three-dimensional weather information, such as radiosonde, aircraft, and radar, is useful information for accurate weather prediction. The observation data provides a vertical distribution of meteorological factors in the atmosphere and greatly contributes to improving performance of numerical forecasts. In particular, observation equipment mounted on atmospheric research aircraft, such as dropsonde and aircraft integrated meteorological measurement system (AIMMS-20), has a big effect on predictability of numerical forecast models through observation and collection of weather information according to a takeoff and landing and a flight path of atmospheric research aircraft, and has the advantage of being able to perform observation and collect data to resolve a maritime observation blank area.

The performance of the numerical model has been improved over decades due to various factors such as improvement in a physical method and application of high resolution. The initial conditions, which are the forecast results of the numerical model, are one of the main factors that greatly affect the accuracy of weather and climate predictions, and various previous studies have shown that the improvements in the initial conditions contribute to the improvement in the prediction performance of the numerical model. In particular, the aircraft observation data have a great advantage of being able to collect data to resolve the maritime observation blank area.

Therefore, the need to establish a data assimilation system for generating improved initial conditions and performing efficient aerial observation work by using the observation data (hereinafter, referred to as ‘atmospheric research aircraft observation data’) acquired from the observation equipment mounted on the above-described atmospheric research aircraft is emerging.

In addition, the need to establish the data assimilation system by using the above-described atmospheric research aircraft observation data and to more efficiently perform aerial observation work and numerical forecast research by improving the prediction accuracy of the numerical model is emerging.

### RELATED ART DOCUMENT

### Patent Document

Korean Patent Laid-Open Publication No. 10-2023-0102217 (published on Jul. 7, 2023)
Korean Patent Laid-Open Publication No. 10-2023-0086347 (published on Jun. 15, 2023)
Korean Patent Laid-Open Publication No. 10-2021-0111579 (published on Sep. 13, 2021)
Korean Patent No. 10-1966639 (published on Jul. 26, 2019)
Korean Patent No. 10-2576775 (published on Sep. 11, 2023)

### SUMMARY

An object to be achieved by the present disclosure is to provide a data assimilation system of numerical models using atmospheric research aircraft observation data for constructing a data assimilation system for generating improved initial conditions and performing efficient aerial observation work using atmospheric research aircraft observation data, and a method of constructing a weather prediction model with data assimilation applied of the data assimilation system.

Another object to be achieved by the present disclosure is to provide a data assimilation system of numerical models using atmospheric research aircraft observation data capable of performing more efficient aerial observation work and numerical forecast research by improving prediction accuracy of a numerical model through a constructed data assimilation system using atmospheric research aircraft observation data, and a method of constructing a weather prediction model with data assimilation applied of the data assimilation system.

Still another object to be achieved by the present disclosure is to provide a system for evaluating performance of a weather prediction model capable of evaluating and analyzing performance of a weather prediction model with data assimilation applied.

A data assimilation system of numerical models using atmospheric research aircraft observation data according to an exemplary embodiment of the present disclosure includes: an observation error data generation module that generates an observation error data based on real measurement data, a background error covariance generation module that generates background error covariance data, which is an error of a background field, based on a difference in prediction between models with different initial times for the same forecast period; a data assimilation module that constructs a weather prediction model with data assimilation applied based on forecast result data of a pre-processed initial weather prediction model, the observation error data, and the background error covariance data; and a lateral boundary field generation module that generates an improved lateral boundary field based on a forecast result of the initial weather prediction model and a forecast result of the weather prediction model with data assimilation applied, and applies the generated improved lateral boundary field to the weather prediction model with data assimilation applied.

The real measurement data may include ADP global upper air and surface weather observation data in a PreparedBUFR (PREPBUFR) format provided by national centers for environmental prediction (NCEP) and data observed by an atmospheric research aircraft, and the data observed through the atmospheric research aircraft may be dropsonde data or aircraft integrated meteorological measurement system (AIMMS-20) data.

The observation error data generation module may extract an observed value within a model execution period and a research area based on the ADP global upper air and surface weather observation data in the PREPBUFR format provided by the NCEP and the data observed by the atmospheric research aircraft by using the OBSPROC which is a program processing the observation data in the data assimilation process.

The observation error data generation module may convert the ADP global upper air and surface weather observation data in the PREPBUFR format provided by the NCEP and the data observed through the atmospheric research aircraft into the LITTLE_R format.

The observation error data generation module may generate the observation error data by combining the ADP global upper air and surface weather observation data in the PREPBUFR format provided by the NCEP converted into the LITTLE_R format and the data observed through the atmospheric research aircraft.

The background error covariance generation module may use a control variable when generating the background error covariance data using a national meteorological center (NMC) method, and the control variable may include a variable of a global mean field (CV3).

The data assimilation module may generate an initial field wrfinput_d01 and an initial boundary field wrfbdy_d01 based on the forecast result data of the initial weather prediction model, and change the generated initial field wrfinput_d01 and initial boundary field wrfbdy_d01 into an initial field wrfvar_output and an initial boundary field wrfbdy to which the data assimilation is applied based on the observation error data and the background error covariance data.

The lateral boundary field generation module may generate the lateral boundary field based on the initial boundary field wrfbdy_d01 of the initial weather prediction model and the initial field wrfvar_output generated through the data assimilation process.

A system for evaluating performance of a weather prediction model according to an exemplary embodiment of the present disclosure includes: an initial weather prediction model; and a data assimilation system that constructs the initial weather prediction model as a weather prediction model with data assimilation applied, in which the data assimilation system includes: an observation error data generation module that generates observation error data based on real measurement data; a background error covariance generation module that generates background error covariance data, which is an error of a background field, based on a difference in prediction between models with different initial times for the same forecast period; a data assimilation module that constructs a weather prediction model with data assimilation applied based on forecast result data of a pre-processed initial weather prediction model, the observation error data, and the background error covariance data; and a lateral boundary field generation module that generates an improved lateral boundary field based on a forecast result of the initial weather prediction model and a forecast result of the weather prediction model with data assimilation applied, and applies the generated lateral boundary field to the weather prediction model with data assimilation applied, and the system for evaluating performance of a weather prediction model compares the forecast result of the initial weather prediction model with the forecast results of the improved lateral boundary field and the weather prediction model with data assimilation applied to evaluate performance of the weather prediction model.

The system for evaluating performance of a weather prediction model may compare, at multiple weather observation points, meteorological variables of an experiment from the initial weather prediction model, an experiment from the weather prediction model with data assimilation, and a result of reanalysis data (ERA5) of ECMWF, respectively, to evaluate the performance of the weather prediction model with data assimilation, and the meteorological variable may include temperature, wind speed, and relative humidity.

The real measurement data may include ADP global upper air and surface weather observation data in a PreparedBUFR (PREPBUFR) format provided by national centers for environmental prediction (NCEP) and data observed by an atmospheric research aircraft, and the data observed through the atmospheric research aircraft may be dropsonde data or aircraft integrated meteorological measurement system (AIMMS-20) data.

According to the data assimilation system of numerical models using atmospheric research aircraft observation data and the method of constructing a weather prediction model with data assimilation applied of the data assimilation system according to the present disclosure, it is possible to construct the data assimilation system for generating improved initial conditions and performing efficient aerial observation work using the atmospheric research aircraft observation data.

According to the data assimilation system of numerical models using atmospheric research aircraft observation data and the method of constructing a weather prediction model with data assimilation applied of the data assimilation system according to the present disclosure, it is possible to perform more efficient aerial observation work and numerical forecast research by improving the prediction accuracy of the numerical model through the constructed data assimilation system using the atmospheric research aircraft observation data.

According to the system for evaluating performance of a weather prediction model of the present disclosure, it is possible to evaluate and analyze the performance of the weather prediction model with data assimilation applied.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating each configuration of a server according to the present disclosure;

FIG. 2 is a flowchart of a method of constructing a weather prediction model with data assimilation applied of a data assimilation system according to the present disclosure;

FIG. 3 is a flowchart illustrating an observation error data generation algorithm of an observation error data generation module according to the present disclosure;

FIG. 4 is a diagram illustrating a structure of a LITTLE_R format;

FIG. 5 is a diagram illustrating ADP global upper air and surface weather observation data in a PREPBUFR format provided by NCEP;

FIG. 6 is a diagram illustrating a state in which an observation error data generation module converts each observed value into the LITTLE_R format;

FIG. 7 is a diagram illustrating a update_bc process for creating an improved lateral boundary field of a lateral boundary field generation module;

FIG. 8 is a diagram illustrating an installation of an NETCDF library for compiling a data assimilation system;

FIG. 9 is a diagram illustrating a state in which an executable file da_wrfvar.exe is installed through a confirmation of environment settings;

FIG. 10 is a block diagram illustrating each configuration of a server according to the present disclosure;

FIG. 11 is a diagram illustrating a research modeling area of a target area;

FIG. 12 is a diagram illustrating a state in which physical options and domain grid information configuration information of a numerical forecast model performed are organized;

FIG. 13 is a diagram illustrating a dropsonde landing point;

FIG. 14 is a diagram illustrating the dropsonde landing time and latitude and longitude information of the landing point;

FIG. 15 is a diagram illustrating a weather observation point of the target area;

FIG. 16 is a diagram illustrating a time series of data assimilation simulation results by observation point of a research period for ground temperature;

FIG. 17 is a diagram illustrating a time series of data assimilation simulation results by observation point of a research period for a ground wind speed;

FIG. 18 is a diagram illustrating a time series of data assimilation simulation results by observation point of a research period for ground relative humidity;

FIG. 19 is a diagram illustrating a statistical model evaluation table through data assimilation application for ground meteorological variables;

FIG. 20 is a diagram illustrating an improvement rate for the data assimilation results;

FIG. 21 is a diagram illustrating a time series of simulation comparison of 850 hPa upper-layer meteorological variables;

FIG. 22 is a diagram illustrating a time series of simulation comparison of 500 hPa upper-layer meteorological variables;

FIG. 23 is a diagram illustrating a statistical model evaluation table for data assimilation results of 850 hPa upper-layer meteorological variables; and

FIG. 24 is a diagram illustrating the statistical model evaluation table for the data assimilation results of 500 hPa upper-layer meteorological variables.

### DETAILED DESCRIPTION OF THE EMBODIMENT

Hereinafter, some exemplary embodiments of the present disclosure will be described in detail with reference to the accompanying drawings. It is to be noted that in giving reference numerals to components of each of the accompanying drawings, the same components will be denoted by the same reference numerals even though they are illustrated in different drawings.

Further, in describing exemplary embodiments of the present disclosure, well-known constructions or functions will not be described in detail in the case in which it is decided that they may unnecessarily obscure the understanding of exemplary embodiments of the present disclosure.

In addition, terms ‘first’, ‘second’, A, B, (a), (b), and the like, will be used in describing components of exemplary embodiments of the present disclosure. These terms are used only in order to distinguish any component from other components, and features, orders, sequences, or the like, of corresponding components are not limited by these terms.

Unless explicitly described in the phrase, a singular form includes a plural form in the present specification. Throughout this specification, the term “comprises” and/or “comprising” will be understood to imply the inclusion of stated constituents but not the exclusion of the presence or addition of one or more other constituents.

In the present disclosure, a relatively stable day affected by high pressure after Typhoon Hinnamno No. 11 in 2022 was set as a model performance period, and a data assimilation system 100 and a numerical model (weather prediction model 20) with data assimilation applied was constructed using a PreparedBUFR (PREPBUFR) format data provided by national centers for environmental prediction (NCEP) and data acquired through observation equipment (dropsonde and/or aircraft integrated meteorological measurement system (AIMMS-20)) mounted on atmospheric research aircraft.

Hereinafter, the present disclosure will be described in detail with reference to the accompanying drawings.

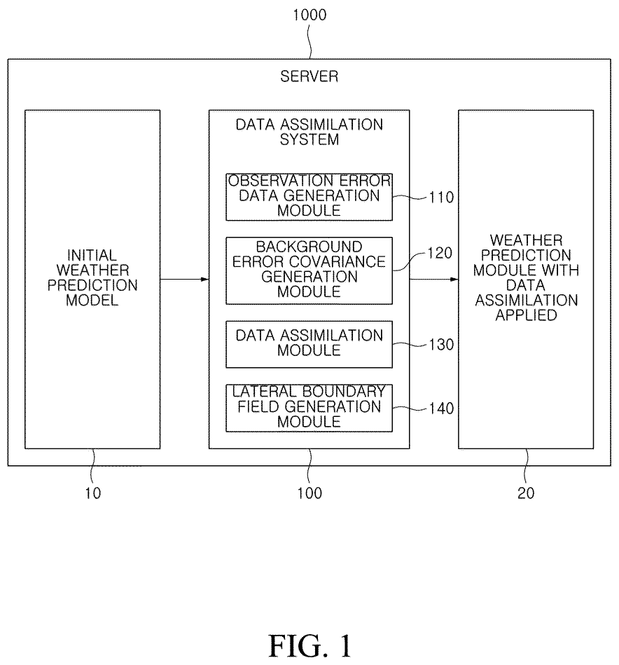

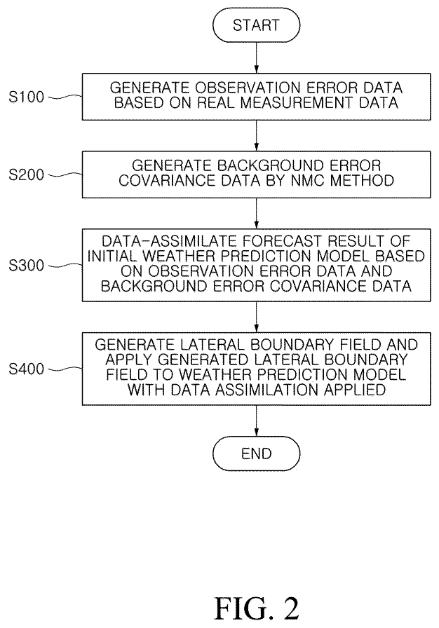

FIG. 1 is a block diagram illustrating each configuration of a server 1000 according to the present disclosure, and FIG. 2 is a flowchart of a method of constructing a weather prediction model 20 with data assimilation applied of the data assimilation system 100 according to the present disclosure.

Referring to FIG. 1, the server 1000 according to the present disclosure includes a data assimilation system 100 of numerical models using atmospheric research aircraft observation data (hereinafter referred to as ‘data assimilation system 100’). The data assimilation system 100 according to the present disclosure includes an observation error data generation module 110, a background error covariance generation module 120, a data assimilation module 130, and a lateral boundary field generation module 140. The data assimilation system 100 according to the present disclosure adjusts a forecast result, initial conditions, etc., of an initial weather prediction model (numerical model 10) to real observation data, etc., and constructs a weather prediction model with data assimilation applied (weather research and forecast build model, WRF, WRF v4.1.2).

In the server 1000 according to the present disclosure, the initial weather prediction model 10 without data assimilation applied may be further constructed as a numerical model. The same equations, dynamics, and physics processes as the Korea Integrated Model system (KIM) may be applied to the initial weather prediction model 10 and the weather prediction model 20 with data assimilation applied, respectively.

The data assimilation system 100 according to the present disclosure performs data assimilation on the forecast result of the initial weather prediction model 10 based on real observation data (real measurement data) to construct the weather prediction model 20 with data assimilation applied. In this case, the real observation data includes ADP global upper air and surface weather observation data in a PreparedBUFR (PREPBUFR) format (hereinafter, referred to as ‘PREPBUFR format data’) provided by national centers for environmental prediction (NCEP), and data observed through atmospheric research aircraft.

In this case, the data observed through the atmospheric research aircraft is dropsonde data and/or aircraft integrated meteorological measurement system (AIMMS-20) data. The dropsonde is a radiosonde dropped from an aircraft with a parachute to measure atmospheric conditions. The aircraft integrated meteorological measurement system is mounted on wings of an atmospheric research aircraft and provides flight information (latitude, longitude, altitude, flight speed, etc.) and weather information (temperature, atmospheric pressure, wind direction, wind speed, relative humidity, etc.) required for analysis.

In detail, the data assimilation system 100 according to the present disclosure generates an initial field wrfinput_d01 and an initial boundary field (initial boundary condition, wrfbdy_d01) based on data pre-processed from the forecast result of the initial weather prediction model 10 constructed in the server 1000 and adjusts the generated initial field wrfinput_d01 and initial boundary field wrfbdy_d01 through real observation data and changes the generated initial field wrfinput_d01 and initial boundary field wrfbdy_d01 to the initial field wrfvar_output and initial boundary field wrfbdy with data assimilation applied. The data assimilation system 100 reduces errors in observed values and background fields through an observation error data (observation preprocessor (OBSPROC)) and background error (BE) covariance in the process of changing the initial field wrfinput_d01 and the initial boundary field wrfbdy_d01 to the initial length wrfvar_output and initial boundary field wrfbdy with data assimilation applied.

Referring to FIG. 2 in detail, the method of constructing a weather prediction model 20 with data assimilation applied of the data assimilation system 100 according to the present disclosure includes an observation error data generation step (S100), a background error covariance data generation step (S200), a data assimilation step (300), and a lateral boundary field generation step (S400).

The data assimilation system 100 according to the present disclosure applies the 3-dimensional variational data assimilation system (3DVAR) as an atmospheric research aircraft observation data assimilation technique. The 3D variational data assimilation system statistically combines observation data and error information from the background field. The 3D variational data assimilation system has the advantage of being able to assimilate various observation data such as radar and GPS precipitable water vapor (PWV).

The variational method newly calculates weights between observation data and prediction data at each prediction time. In this case, the weight obtained by calculating the differential equation minimizes the error in the analysis field. In general, when the latitude, longitude, and altitude are considered during data assimilation, it is called 3-dimensional variational data assimilation (3DVAR), and when the data assimilation also considers the observation time of the observation data, it is called 4-dimensional variational data assimilation (4DVAR).

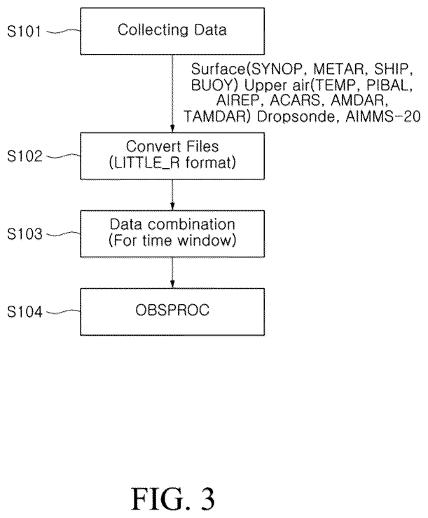

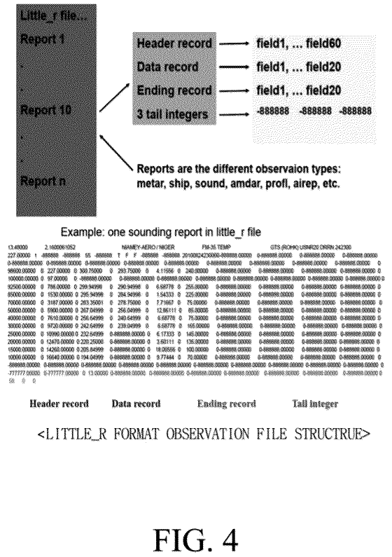

FIG. 3 is a flowchart illustrating the observation error data generation algorithm of the observation error data generation module 110 according to the present disclosure, and FIG. 4 is a diagram illustrating the structure of the LITTLE_R format.

In the observation error data generation step (S100), the observation error data generation module 110 generates the observation error data based on the real observation data.

Referring to FIG. 3, the observation error data generation module 110 uses the OBSPROC to remove observed values outside the time and study area other than the model execution period based on the PREPBUFR format data, the dropsonde data observed through the atmospheric research aircraft, and the aircraft integrated meteorological measurement system data (hereinafter, referred to as ‘AIMMS data’), thereby extracting the observed values within the model execution period and within the study area (S101). The OBSPROC is a program that processes the observation data in the data assimilation process and processes the observation data in the LITTLE_R format.

The observation error data generation module 110 extracts the atmospheric pressure and altitude information from the observed value extracted using static assumptions. The observation error data generation module 110 confirms a vertical consistency of the extracted observed value, assigns the observation error, and outputs the observation error in the observation data format usable in the data assimilation system 100, that is, the LITTLE_R format (S102). Referring to FIG. 4, the structure of the LITTLE_R format has structures of header record, data record, ending record, and tail integer. However, it is not limited thereto, and the structure of the LITTLE_R format may have different areas and values depending on the observation data.

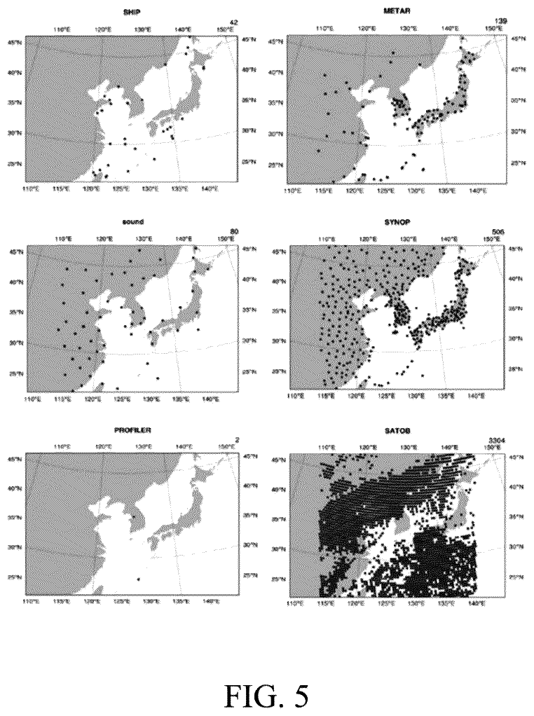

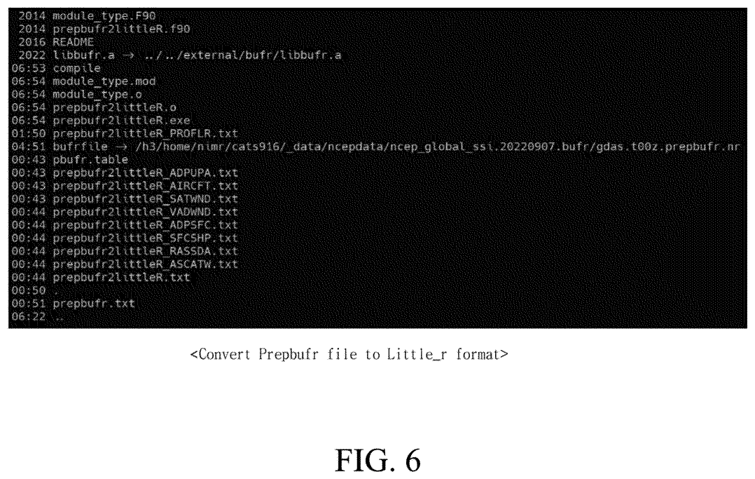

FIG. 5 is a diagram illustrating the ADP global upper air and surface weather observation data in the PREPBUFR format provided by the NCEP, and FIG. 6 is a diagram illustrating a state in which the observation error data generation module 110 converts each observed value into LITTLE_R format.

As an example, in order to generate the observation error data, referring to FIGS. 3 to 5, the observation error data generation module 110 converts the PREPBUFR format data (SYNOP, SHIP, Kalpana-1, METEOSAT-6, GMS, GOES, SATOB, SOUND, PROFILER, METAR) provided by the NCEP into the LITTLE_R format.

In addition, the observation error data generation module 110 also converts the dropsonde data and AIMMS data observed through the atmospheric research aircraft into the LITTLE_R format.

The observation error data generation module 110 combines the PREPBUFR format data converted into the LITTLE_R format with the observed values in the dropsonde data and AIMMS data (S103).

Referring to FIG. 6, the observation error data generation module 110 converts each observed value into the LITTLE_R format.

The LITTLE_R format conversion process of the observation error data generation module 110 is described in detail. The observation error data generation module 110 executes a data conversion program (run prepbufr2littleR.exe) that links the PREPBUFR format data (gdas.t00z.prepbufr.nr) provided by the NCEP to bufrfile in the data assimilation system 100 and then converts the bufrfile into the LITTLE_R format. When the program is completed, a total of 8.txt files (ADPSFC, ADPUPA, AIRCFT, ASCATW, RASSDA, SATWND, SFCSHP, VADWND) are generated. The observation error data generation module 110 then performs a process of merging all the converted LITTLE_R files by executing instructions.
>bufrfile->/home/ncepdata/ncep_global_ssi.20220907.bufr/gdas.t00z.prepbufr.nr
>./prepbufr2littleR.exe
>Is prepbufr2littleR_*|xargs cat>prepbufr.txt (prepbufr.txt file generation)

In the case of the dropsonde and AIMMS data, which are the atmospheric research aircraft observation data, the process of converting data into the LITTLE_R format is required, like the PREPBUFR format data. However, since the PREPBUFR format data and atmospheric research aircraft observation data have different data formats, they may be subjected to the conversion process using a separately developed script. The observation error data generation module 110 generates the observation error data (OBSPROC) by combining the atmospheric research aircraft observation data (dropsonde data, AIMMS data) converted into the LITTLE_R format and the PREPBUFR format data (S104).
>gfortran AIMMS2LITTLER.f90 or DROP2LITTLER.f90
>AIRCRAFT.yyyymmddhhmmss or DROP.yyyymmddhhmmss generation
>cat AIRCRAFT. or DROP.+prepbufr.txt>conv.txt (conv.txt file generation)

The observation error data generation module 110 sets the namelist file (namelist.obsproc) using the generated conv.txt (NCEP prepbufr, dropsonde, AIMMS) file and then completes the observation error data generation process.
. . . /WRFDA/var/obsproc
>cp namelist.obsproc.3dvar.wrfvar-tut namelist.obsproc
>./obsproc.exe>&obsproc.out
>obs_gts_YYYY-MM-DD_HH: 00:00.3DVAR generation

In the background error covariance data generation step (S200), the background error covariance generation module 120 generates the background error covariance through the background error covariance process. The background error refers to the error (background error BE) of the background field.

In order to generate the background error covariance, as an example, the background error covariance generation module 120 generates the background error covariance using the national meteorological center (NMC) method. The NMC method is a method of generating background error covariance as a prediction difference between models with different initial times for the same forecast period, and is one of the techniques used to evaluate the background error covariance.

In the process of generating the background error covariance using the NMC method, a lot of computer resources are required when calculating the covariance using the model variables. As a means to reduce this, the control variable is used, and the control variable utilizes streamfunction (ψ), unbalanced velocity potential (χu), unbalanced temperature (Tu), pseudo relative humidity (RHs), and unbalanced surface pressure (Ps, u), q, u, v, temperature, etc.

As an example, the background error covariance generation module 120 according to the present disclosure uses variables of a global mean field CV3 provided internally within the numerical model. The variables of the global mean field CV3 include streamfunction (w), unbalanced velocity potential (xu), unbalanced temperature (Tu), q, and unbalanced surface pressure (Ps,u), as shown in Table 1 below.

TABLE 1
<Background error (BE) covariance options in WRFDA>

| CV | | | |
|---|---|---|---|
| option | Data source | Control variables | cv_options = |
| CV3 | Provided be.dat file | ψ, χu, Tu, q, Ps, u | 3 |
| CV5 | GEN_BE | ψ, χu, Tu, RHs, Ps, u | 5 |
| CV6 | GEN_BE | ψ, χu, Tu, RHs, u, Ps, u | 6 |
| CV7 | GEN_BE | u, v, T, RHs, Ps | 7 |

In the data assimilation step 300, the data assimilation module 130 performs the data assimilation on the forecast result data of the pre-processed initial weather prediction model 10 based on the observation error data and background error covariance data to construct the weather prediction model 20 with data assimilation applied (weather research forecasting data assimilation (WRFDA)).

The data assimilation module 130 performs the pre-processing (WRF pre-processing system, WPS) of the forecast result of the initial weather prediction model 10 (weather research and forecasting (WRF)). The data assimilation module 130 generates the initial field wrfinput_d01 and the initial boundary field wrfbdy_d01 from data obtained by pre-processing the forecast result of the initial weather prediction model 10.

The data assimilation module 130 changes the initial field wrfinput_d01 and initial boundary field wrfbdy_d01 generated from data obtained by pre-processing the forecast result of the initial weather prediction model 10 to the initial field wrfvar_output and initial boundary field wrfbdy with data assimilation applied based on the real observation data, that is, the observation error data and background error covariance data, thereby constructing the weather prediction model 20 with data assimilation applied (WRFDA).

The data assimilation module 130 generates all input data, including the observation error data (ob.ascii) generated in the observation error data generation step (S100) and the background error (be.dat) generated in the background error covariance data generation step (S200), and then links related files such as the forecast result data, the observation error data, and the background error data of the initial weather prediction model 10 pre-processed in the final execution directory. When linking the related files, the data assimilation module 130 modifies namelist.input according to the experiment to perform a first guess (fg) of the weather prediction model described above and then executes da_wrfvar.exe.
. . . /WRFDA/workdir
>ln-sf $WRFDA_DIR/run/LANDUSE.TBL
>ln-sf $ . . . /wrfinput_d01./fg
>ln-sf $ . . . /obsproc/obs_gts_YYYY-MM-DD_HH: 00:00.3DVAR./ob.ascii
>ln-sf $DAT_DIR/be/be.dat be.dat.cv3
>ln-sf $WRFDA_DIR/var/da/da_wrfvar.exe.
>ln-sf $DAT_DIR/ob/gdas1.txxz.prepbufr.nr ob.bufr
>da_wrfvar.exe>& wrfda.log (wrfvar_output generation)

In the lateral boundary field generation step (S400), the lateral boundary field generation module 140 generates the more improved lateral boundary field (lateral boundary condition) than the lateral boundary field (lateral boundary condition) of the initial weather prediction model 10 based on the forecast result data of the initial weather prediction model 10 and the forecast result of the weather prediction model 20 (WRFDA) constructed through the data assimilation process. The lateral boundary field generation module 140 applies (updates) the generated improved lateral boundary field to weather prediction model 20 with data assimilation applied. The lateral boundary field generation module 140 generates the forecast result from the weather prediction model 20 with data assimilation applied (WRFDA) through the weather prediction model 20 (WRFDA) to which the improved lateral boundary field is applied.

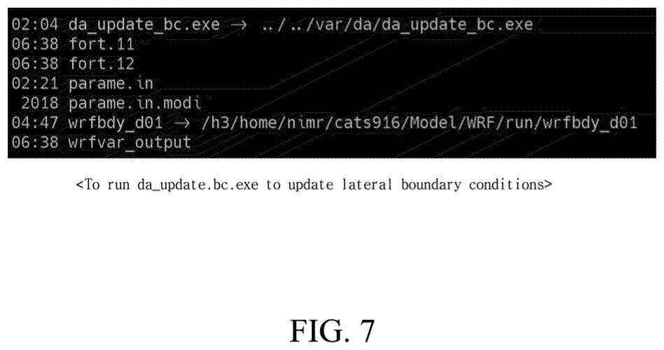

FIG. 7 is a diagram illustrating a update_bc process for generating the improved lateral boundary field of the lateral boundary field generation module 140.

In detail, the lateral boundary field generation module 140 performs a update_bc process to generate the improved lateral boundary field, as illustrated in FIG. 7, based on the initial boundary field wrfbdy_d01 of the initial weather prediction model 10 and a new initial field wrfvar_output generated through the data assimilation process.
. . . /WRFDA/workdir/update_bc
>ln-sf $WRFDA_DIR/run/LANDUSE.TBL
>cp-p $DAT_DIR/wrfbdy_d01
>vi parame.in (update_bc namelist file)
>ln-sf $WRFDA_DIR/var/da/update_bc.exe
>./da_update_bc.exe

The lateral boundary field generation module 140 changes the initial field wrfvar_output and the initial boundary field wrfbdy to which the data assimilation generated through the update_bc process is applied to the same name as the initial field wrfinput_d01 generated from the real observation data, and finally performs the weather prediction model 20 with data assimilation applied (WRFDA) to generate the forecast results from the weather prediction model 20 with data assimilation applied.
. . . /WRF/run
>mv wrfvar_output wrfinput_d01
>cp wrfbdy_d01 . . . /WRF/run/.

As described above, in the server 1000, not only the data assimilation system 100 (WRF data assimilation system (WRFDA)), but also the initial weather prediction model 10 to which the same equation and dynamics/physics process as the Korea integrated model system (KIM) is applied is further constructed.

The same dynamics/physics process as the KIM model applied to the initial weather prediction model 10 may include WDM7 in the microscopic (precipitation) physics process, RRTMG_K for a radiation physics course (long wave), KIAPS SAS for a cumulus parameterization process, etc.

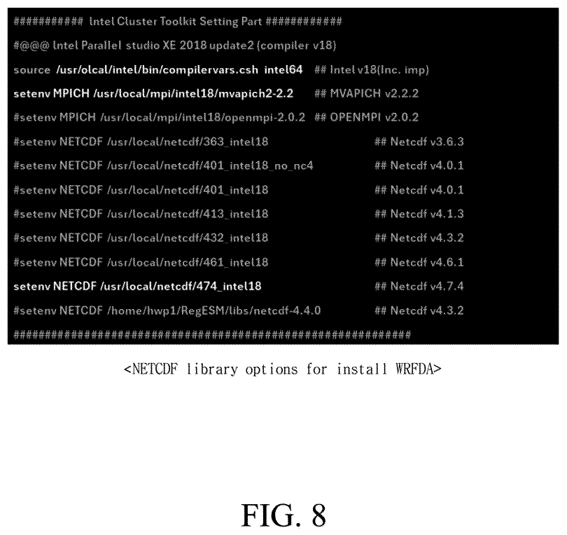

FIG. 8 is a diagram illustrating an installation of an NETCDF library for compiling the data assimilation system 100.

When constructing the initial weather prediction model 10 and the data assimilation system 100, as a special point, the initial weather prediction model 10 and the data assimilation system 100 should be separately configured and compiled. In addition, in order to compile the data assimilation system 100, as illustrated in FIG. 8, the NETCDF library should be installed. The server 1000 environment according to the present disclosure is set to intel as an example.
>setenv NETCDF your_netcdf_path
>export NETCDF=your_netcdf_path

The compilation and installation process of the data assimilation system 100 is performed as follows, and the relevant information may be obtained at https://www2.mmm.ucar.edu/wrf/users/wrfda/.
>my WRF WRFDA
>cd $WRFDA
>./configure wrfda (machine information setting)

When the model configuration options are generated, the options appropriate for the machine are selected and then the compilation process is performed.
>./compile all_wrfvar>& compile.out
>ls-1 var/build/*exe var/obsproc/src/obsproc.exe

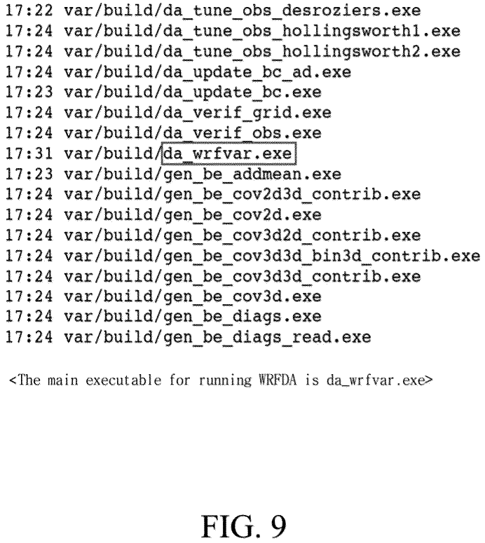

FIG. 9 is a diagram illustrating a state in which an executable file da_wrfvar.exe is installed through a confirmation of environment settings.

In this case, the executable file (da_wrfvar.exe) should essentially be installed, and when it is not installed, reconfirm the environmental settings as illustrated in FIG. 9.

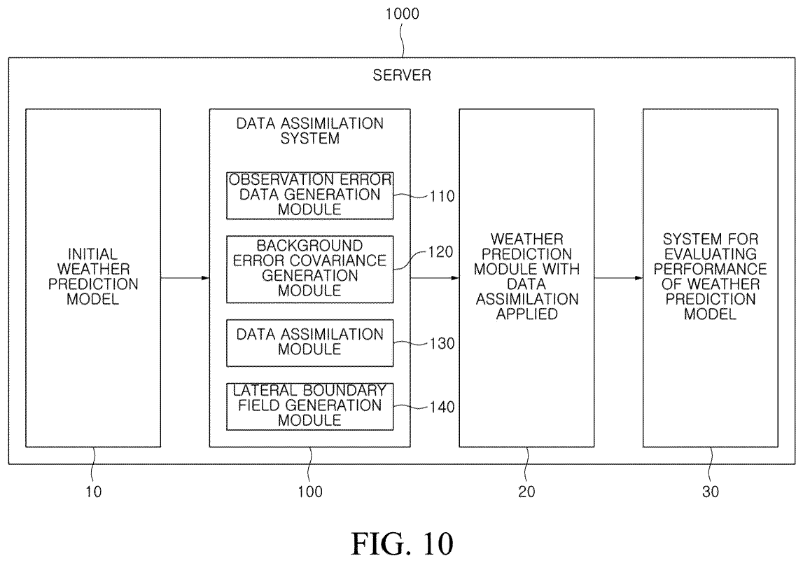

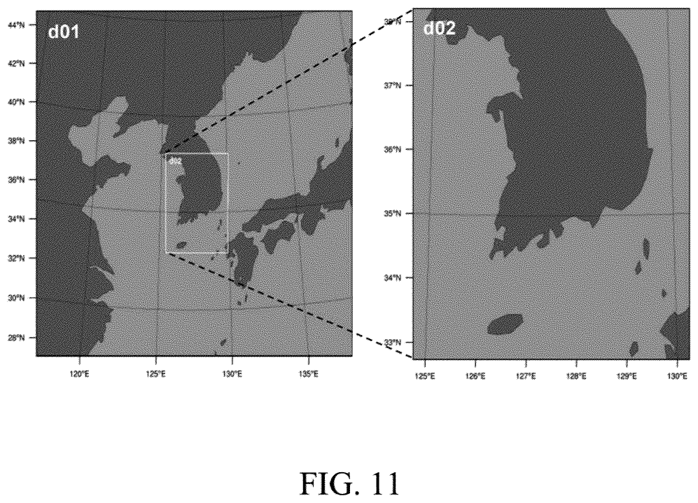

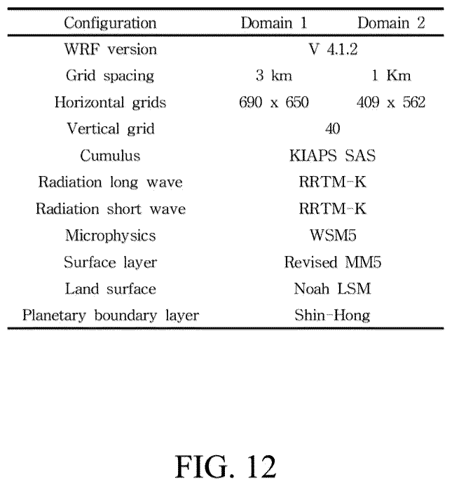

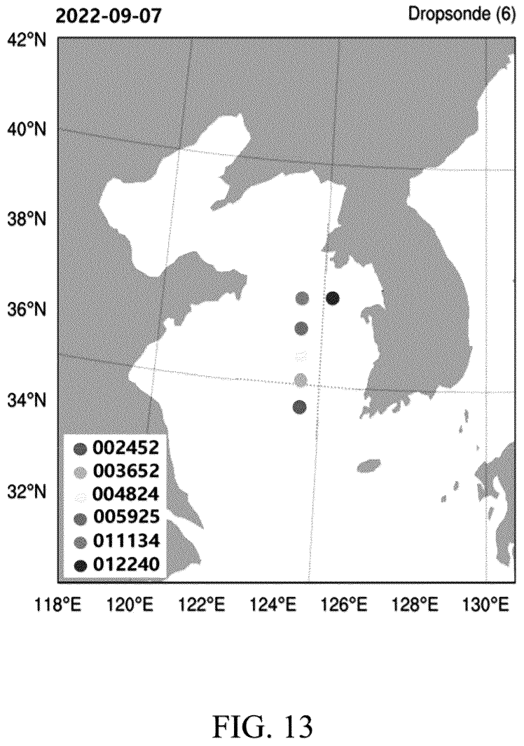

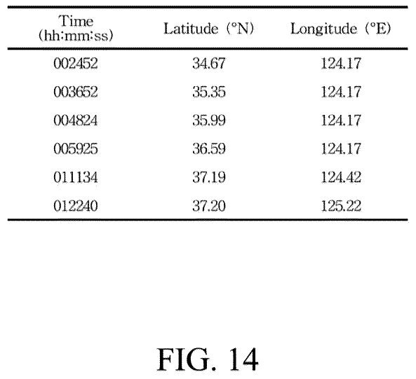

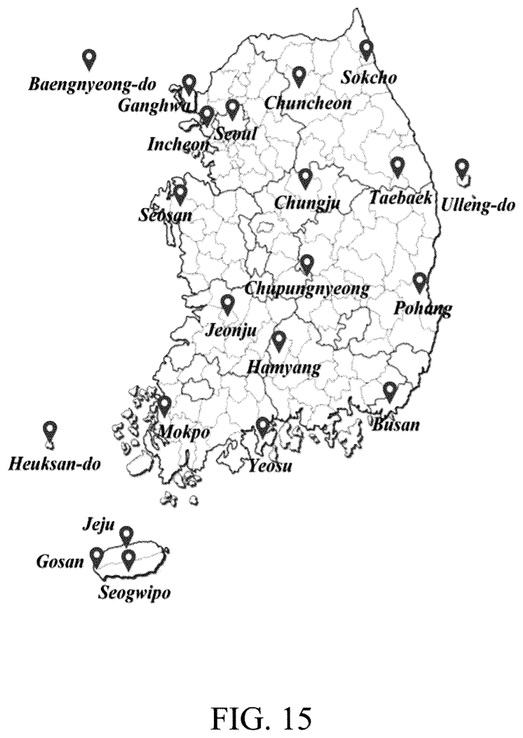

FIG. 10 is a block diagram illustrating each configuration of a server according to the present disclosure. FIG. 11 is a diagram illustrating a research modeling area of a target area, and FIG. 12 is a diagram organizing the physical options and domain grid information configuration information of the performed numerical forecast model. FIG. 13 is a diagram illustrating a dropsonde landing point. FIG. 14 is a diagram illustrating the dropsonde landing time and the latitude and longitude information of the landing point. FIG. 15 is a diagram illustrating a weather observation point of the target area.

Referring to FIG. 10, a system 30 for evaluating performance of a weather prediction model according to the present disclosure compares the forecast result of the initial weather prediction model 10 with the forecast result of the weather prediction model 20 with data assimilation applied to evaluate the performance of the weather prediction model. In this case, the weather prediction model 20 with data assimilation applied includes the weather prediction model 20 to which the above-described improved lateral boundary field is applied together.

The initial weather prediction model 10 according to the present disclosure is weather research and forecasting (WRF) version 4.1.2, which is composed of the same physical process as KIM-Meso that is a mid-scale model used in the field, and uses FNL reanalysis data to generate the initial field and boundary field.

The initial weather prediction model 10 according to the present disclosure is an example. Referring to FIGS. 11 and 12, the horizontal resolution is 3 km and 1 km, respectively, and generates domain 1 d01 and domain 2 d02 having grid sizes of 690×650 and 409×562. The initial weather prediction model 10 according to the present disclosure applied the data assimilation technique of 3 dimensional variational (3DVAR) as described above when generating the domain 1 d01 and domain 2 d02, and the prediction time was 144 hours (6 days), and excludes 48 hours corresponding to a spin-up period to evaluate the accuracy of the model. In addition, the initial weather prediction model 10 was configured to include 40 vertical layers with a maximum atmospheric height of 50 hPa when generating the domain 1 d01 and domain 2 d02, and used WSM5 as a microphysics method, Shin-Hong as an atmospheric boundary layer parameterization method, RRTM_K as a shortwave and longwave radiation method, KIAPS SAS as a cumulus parameterization method, and Noah LSM as a ground physics method.

The model performance period (study case date) was selected as a relatively stable day affected by high pressure after the invasion of a typhoon (Typhoon No. 11 Hinnamno in 2022). Referring to FIG. 13, among the case days, data generated during the aircraft observation performed once in the West Sea on Sep. 7, 2022, and data generated by the dropsonde dropped a total of 6 times were used. Detailed latitude and longitude information of the dropsonde that was dropped a total of 6 times is shown in FIG. 14.

Thereafter, as described above, the weather prediction model 20 with data assimilation applied was constructed in the server 1000 based on the initial weather prediction model 10. In addition, a simulation performance comparison experiment between each model was performed through a comparison between an experiment through the weather prediction model 20 with data assimilation applied constructed through the data assimilation system 100 according to the present disclosure and an experiment through the weather prediction model without data assimilation applied.

To compare the model results, the initial condition experiment was performed using the final (FNL) analysis field provided by the national centers for environmental prediction (NCEP) as the initial field and boundary field (boundary condition) of the model, and ECMWF ReanAlysis Version 5 (ERA5) reanalysis field that is reanalysis data of European Center for Medium-Range Weather Forecasts (ECMWF) was used to compare data assimilation sensitivity experiments. In addition, to evaluate the predictive performance of the model during the case period, as illustrated in FIG. 15, meteorological variables of meteorological observation points located in the target area were used, and the observed and simulated values were statistically compared and analyzed.

The statistical analysis analyzes index of agreement (IOA), root mean square error (RMSE), and mean bias error (MBE) for each observed value and model value of meteorological elements, and IOA, which has a value between 0 and 1, means that the closer it is to 1, the higher the agreement is, and the RMSE and MBE have smaller errors as they approach 0, so it is determined that the model is simulated well.

In order to evaluate the prediction performance of the model and examine the regional characteristics of the data assimilation effect during the case period, as illustrated in FIG. 15, the observation data from a total of 19 synoptic meteorological observation points in South Korea distributed throughout South Korea were used, and the meteorological variables used the time-specific data of temperature, wind speed, and relative humidity.

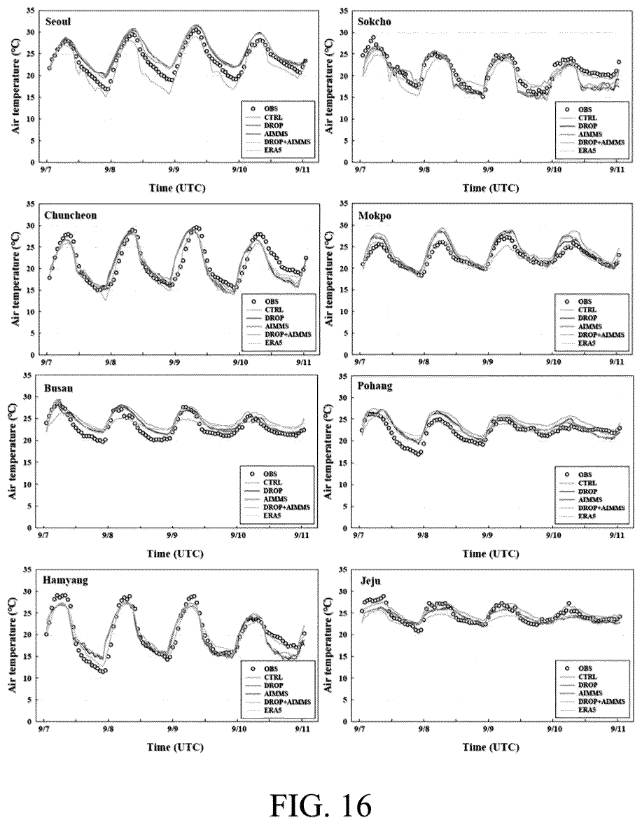

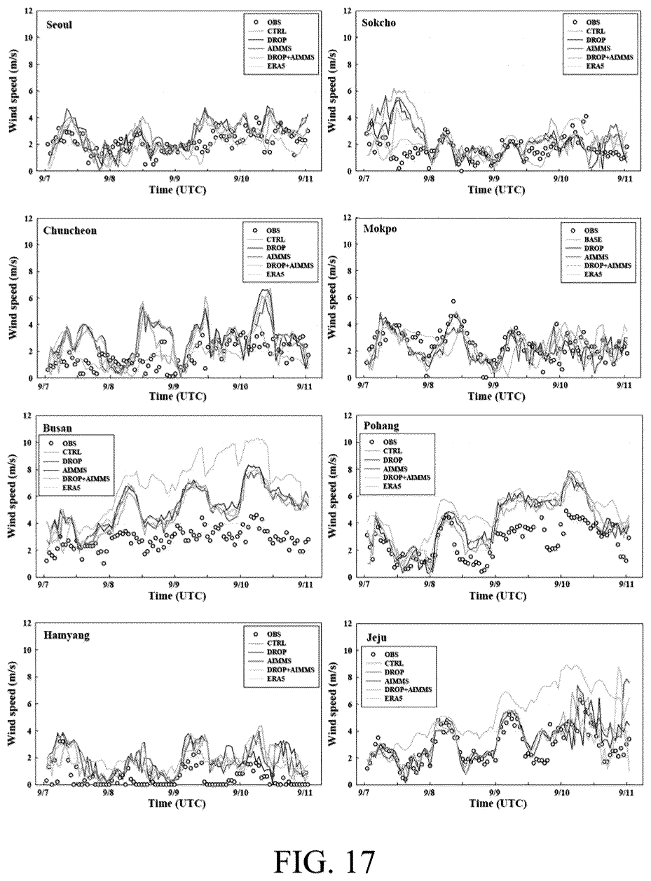

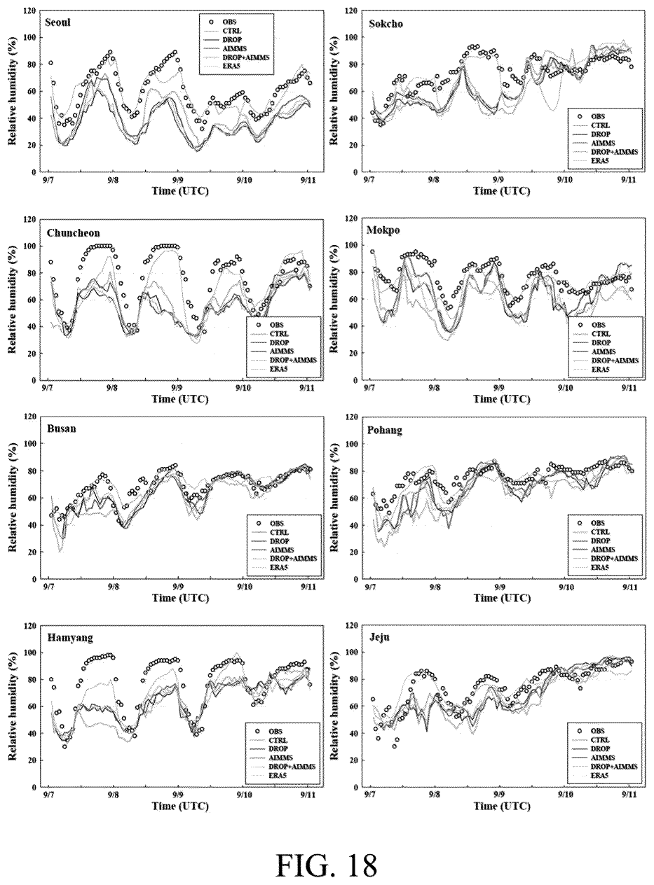

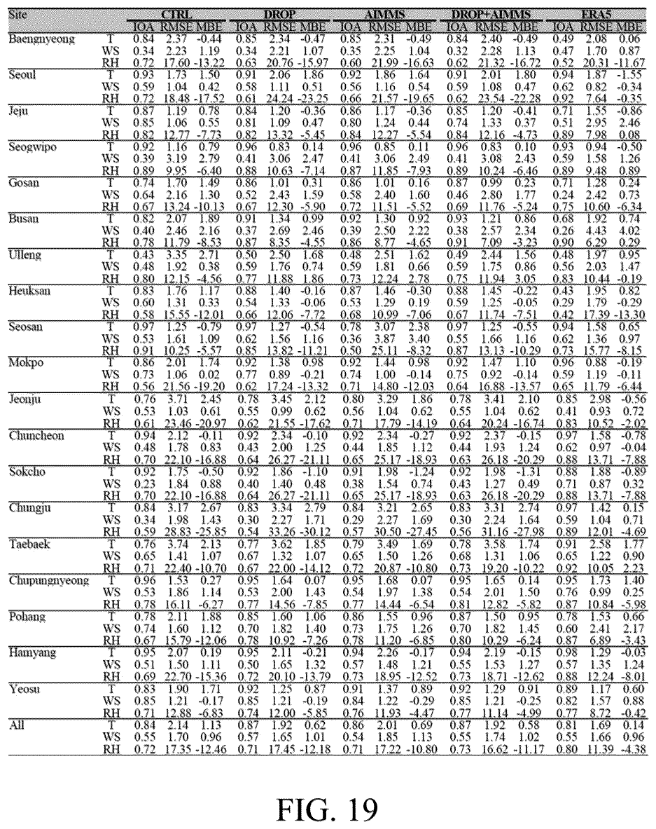

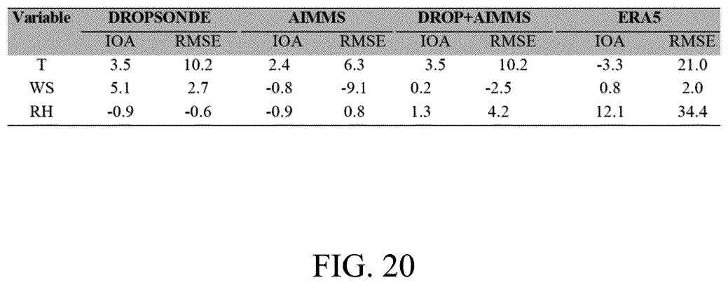

FIG. 16 is a diagram illustrating a time series of data assimilation simulation results by observation point of a research period for ground temperature. FIG. 17 is a diagram illustrating a time series of data assimilation simulation results by observation point of a research period for a ground wind speed. FIG. 18 is a diagram illustrating a time series of data assimilation simulation results by observation point of a research period for ground relative humidity. FIG. 19 is a diagram illustrating a statistical model evaluation table through data assimilation application for ground meteorological variables. FIG. 20 is a diagram illustrating an improvement rate for the data assimilation results.

Referring to FIG. 16, meteorological variables (temperature, wind speed, relative humidity) of an experiment from the initial weather prediction model 10 without applying data assimilation at weather observation points (19 points) during the numerical simulation period (Sep. 7 to 11, 2022) (hereinafter, referred to as the ‘CTRL experiment’), an experiment (DA: DROP, AIMMS, DROP+AIMMS, hereinafter, referred to as ‘DA’ experiment) from the weather prediction model 20 with data assimilation applied, and the results of the ECMWF reanalysis data (ERA5) may be compared. Overall, although there are some differences depending on the observation point, the DA experiment showed generally improved results than the CTRL experiment in all the meteorological variables. Temperature showed the improved results in the DROP, AIMMS, and DROP+AIMMS test results excluding ERA5, and the wind speed showed the improved results in the DROP, DROP+AIMMS test results excluding the AIMMS. A clear difference was confirmed in the statistical analysis for the simulation verification, and the difference is illustrated in FIGS. 19 and 20.

Referring to FIG. 16, looking at the temperature, overall, the numerical simulation results excluding the observed value showed a tendency to simulate the highest temperature at daytime better than the lowest temperature at night, and among them, the CTRL experiment generally had higher RMSE values and tended to oversimulate compared to the DA (DROP, AIMMS, DROP+AIMMS) experiments. On the other hand, the ERA5 showed a tendency to under-simulate compared to the observed values. In most experiments, the DA results were simulated closer to the observed value than the CTRL results, but there were cases where the CTRL experiment was simulated closer to the observed value at some time zones. For example, during the night and morning hours of the numerical simulation period, the DA experiment results applying the data assimilation generally showed the clear improvement compared to the CTRL experiment, but during some daytime hours (around noon) in Seoul and Chuncheon branches, the CTRL result without applying data assimilation showed a rather low RMSE value and the simulation result close to the observed value.

As illustrated in FIG. 17, in terms of the improvement effect of the data assimilation on wind speed, the CTRL experiment generally showed a tendency to oversimulate the observed value, and in the DA experiment, this aspect was improved and the observed value was simulated more closely. For example, in the Seoul and Sokcho branches, the improvement effect of the DA experiments (DROP, AIMMS, DROP+AIMMS) was generally clear compared to the over-simulated CTRL experiment at time zones around noon and midnight during the day. By reducing the oversimulation of the CTRL experiment was reduced to about 2 m/s or less between noon on September 7 and early morning on September 8 at the Sokcho and Chuncheon branches, the ERA 5 showed very similar characteristics to the observed value, but showed strong oversimulation at observation points near the coast, such as Busan, Pohang, and Jeju. This is believed to be because the geographical characteristics (e.g., complex areas adjacent to the coast and surrounded by many islands, etc.) of the real observation point were processed in the model as a large grid space within the area, resulting in some errors.

Referring to FIG. 18, looking at the time series characteristics of the relative humidity, it was found that the model partially failed to simulate the somewhat dry atmospheric state of the observed value during the numerical simulation period. However, in general, it may be confirmed that the simulation results of the DA experiment were better than the CTRL experiment results. In particular, the under-simulated CTRL results at Mokpo, Busan, Pohang, and Hamyang branches on September 7 to 8 during the simulation period showed the improved improvement through the application of data assimilation. ERA5, which is the reanalysis data, showed a closer simulation to the observed value than other DA experiments in all regions.

In order to more accurately quantitatively verify the data assimilation simulation results of system 30 for evaluating the performance of the weather prediction model according to the present disclosure, the statistical (IOA, RMSE, MBE) analysis is performed between the observed values and model values, and the results are shown in FIG. 19. Overall, looking at the average value of 19 points (All), the DA experiment results were improved by being simulated closer to the observed value compared to the CTRL experiment, but different results were shown depending on the meteorological variables. In the case of the temperature, the IOA by the DA (DROP+AIMMS) experiment was improved from a minimum of 0.84 to 0.87 compared to the CTRL experiment, and the RMSE was lowered from a minimum of 2.14° C. to 1.92° C., reducing the error. The DA experiment also showed the improved simulation results compared to the CTRL experiment in the wind speed and relative humidity results. First, in the case of the wind speed, compared to the CTRL experiment results, the IOA of the DA results (DROP+AIMMS) was improved from 0.55 to 0.57, and the RMSE was decreased from 1.70 m/s to 1.65 m/s. Meanwhile, the wind speed at points (Baengnyeong Island, Seogwipo, Busan, Ulleungdo, etc.) showing relatively low simulation accuracy is due to the fact that the real geographical characteristics were processed into a large grid space within the area in the model, resulting in some errors, as described above. In the case of the relative humidity, compared to the results of the CTRL experiment, the IOA of the DA results (DROP+AIMMS) was improved from 0.72 to 0.73, and the RMSE error was reduced from 17.35% to 16.62% In addition, in the case of the relative humidity, the results of the ERA5 experiment showed significant improvement (IOA: 0.80, RMSE: 11.39).

The improvement rate related to the statistical analysis between the observed value obtained by averaging all points (19) and the model value is illustrated in FIG. 20. Referring to FIG. 20, overall, the improvement rates of the data assimilation effect of the temperature were IOA of 2.4% to 3.5% and RMSE of 6.3% to 10.2%, which were higher than those of other meteorological variables. In particular, the experimental results of the DROPSONDE and dropsonde+AIMMS (DROP+AIMMS) showed a high IOA improvement rate. On the other hand, in the case of the ERA5, which is a reanalysis field, IOA was −3.3%, which showed a lower simulation improvement rate than the CTRL experiment, but RMSE was 21%, which showed a high improvement rate. In the case of the wind speed, the dropsonde experiment showed the highest IOA value of 5.1% and the RMSE improvement rate of 2.7%, and in the case of the AIMMS experiment, the simulated improvement rate actually decreased to −0.8%. The relative humidity showed an improvement rate of −0.9 to 1.3%, but the improvement rate actually decreased in the remaining experiments except for the dropsonde+AIMMS experiment (1.3%). On the other hand, the ERA5 reanalysis field showed high improvement rates of IOA 12.1% and RMSE 34.4%.

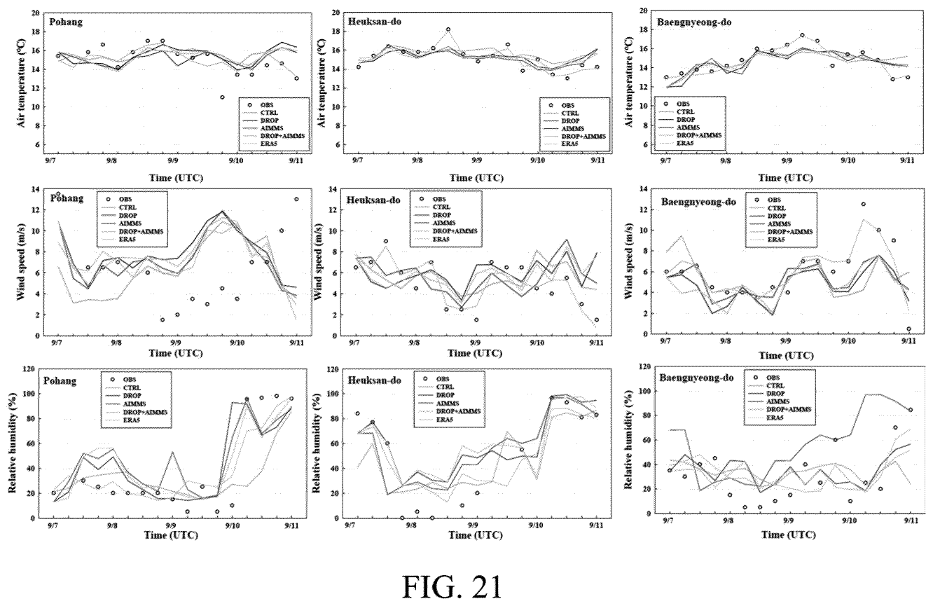

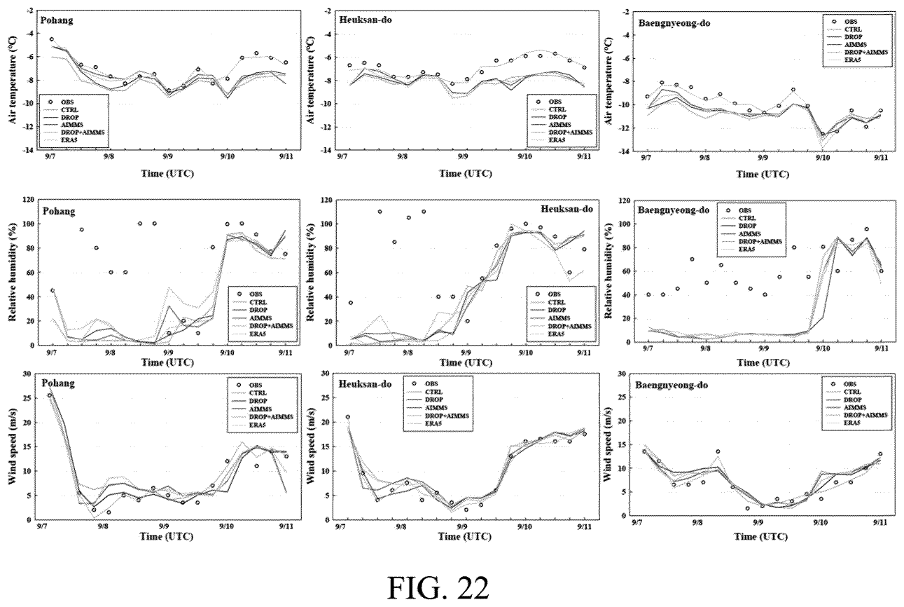

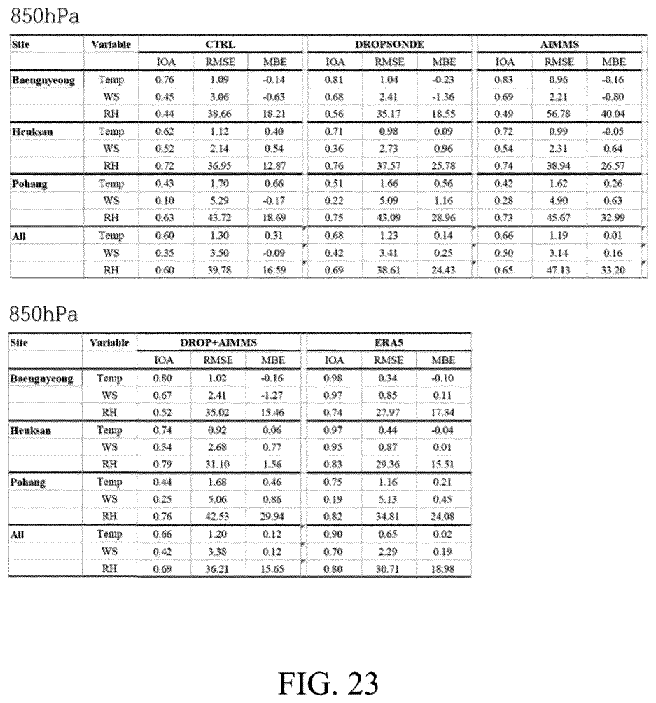

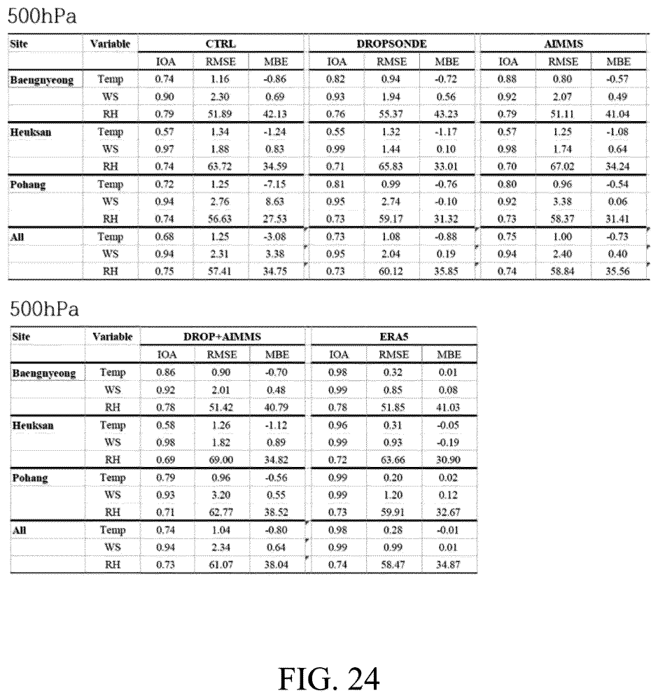

FIG. 21 is a diagram illustrating a time series of simulation comparison of 850 hPa upper-layer meteorological variables. FIG. 22 is a diagram illustrating a time series of simulation comparison of 500 hPa upper-layer meteorological variables. FIG. 23 is a diagram illustrating a statistical model evaluation table for data assimilation results of 850 hPa upper-layer meteorological variables. FIG. 24 is a diagram illustrating the statistical model evaluation table for the data assimilation results of 500 hPa upper-layer meteorological variables.

FIGS. 21 and 22 are diagrams illustrating the data assimilation effect for the upper layer (850 hPa and 500 hPa). Referring to FIGS. 21 and 22, overall, the simulation results in the upper layer showed higher simulation accuracy compared to the simulation results on the ground in all the meteorological factors. For the wind speed at an altitude of 850 hpa, the experiment applying the AIMMS showed the best simulation accuracy at all points, and the DROPSONDE and DROP+AIMMS experiments showed similar simulation results. On the other hand, at an altitude of 500 hpa, the experimental results applying the DROPSONDE showed the highest simulation accuracy, and the model's tendency to oversimulate in the CTRL experiment was corrected to be similar to the observed value.

When the relative humidity of 850 hpa was viewed as a three-point average, the CTRL experiment showed an IOA of 0.60, while the DROPSONDE and DROP+AIMMS experiments showed an IOA of 0.69 and the AIMMS experiment showed an IOA of 0.65. The relative humidity at an altitude of 500 hpa, including the ERA5, tended to not be simulated well in the first half and showed characteristics of being simulated starting from September 10th.

Referring to FIGS. 23 and 24, in the experiment in which the DROPSONDE was applied as an upper-layer altitude model evaluation using the high-layer observation data, the RMSE for the temperature at an attitude of 850 hPa was improved by about 0.2 on average, and the RMSE for wind speed was improved by about 0.4 on average. In addition, for an altitude of 500 hpa, the RMSE was improved by about 0.3 on average for both the temperature and wind speed.

In the present disclosure, the weather prediction models 10 and 20 and the data assimilation system 100 that apply the same equations and physical processes as KIM-meso currently used in the field for the development of the numerical model data assimilation research and utilization technology of the atmospheric research aircraft observation data were constructed. In addition, the simulation performance comparison experiment between the model results was performed to conduct the efficient aerial observation tasks and study the numerical forecasts. Overall, although there are some differences depending on the observation point, the experiments with data assimilation applied to all the meteorological variables generally showed the improved results compared to experiments without data assimilation applied. In particular, the temperature showed the improved results in all the experiments (DROP, AIMMS, DROP+AIMMS) with data assimilation applied, and the wind speed showed the improved simulation results in the DROP, DROP+AIMMS results except for AIMMS. In the case of the relative humidity, it was found that the model failed to partially simulate the somewhat dry atmospheric state of the observed value, but in general, it was confirmed that the simulation results of the experiment with data assimilation applied were improved compared to the CTRL experiment.

In the statistical analysis for more accurate quantitative verification, the improvement rates of the data assimilation effect of the temperature were IOA of 2.4 to 3.5% and RMSE of 6.3 to 10.2%, and the wind speed showed the improvement rates of IOA of 5.1% and RMSE of 2.7% in the DROP experiment. The relative humidity showed the improvement rate of 1.5% in the DROP+AIMMS experiment, but showed the decrease in other experiments.

In this specification, the server 1000, the initial weather prediction model 10, the data assimilation system 100, the observation error data generation module 110, the background error covariance generation module 120, the data assimilation module 130, the lateral boundary field generation module 140, the weather prediction model 20 with data assimilation applied, and the system 30 for evaluating performance of a weather prediction model may be processors that execute continuous execution processes stored in memory. Alternatively, they may operate as software modules driven and controlled by the processor. Furthermore, the processor may be a hardware device.

For reference, the method of constructing a weather prediction model 20 with data assimilation applied of the data assimilation system 100 according to an exemplary embodiment of the present disclosure may be implemented in the form of program commands that may be executed through various computer means and recorded on a computer-readable recording medium. The computer-readable recording medium may include a program command, a data file, a data structure, or the like, alone or a combination thereof. The program commands recorded in the computer-readable recording medium may be especially designed and configured for the present disclosure or be known to those skilled in a field of computer software. Examples of the computer-readable recording medium may include a magnetic medium such as a hard disk, a floppy disk, or a magnetic tape, an optical recording medium such as a compact disk read only memory (CD-ROM) or a digital versatile disk (DVD), a magneto-optical medium such as a floptical disk, and a hardware device specially configured to store and execute program commands, such as a read only memory (ROM), a random access memory (RAM), a flash memory, or the like. Examples of the program commands include a high-level language code capable of being executed by a computer using an interpreter, or the like, as well as a machine language code made by a compiler. The above-mentioned hardware device may be constituted to be operated as one or more software modules in order to perform an operation according to the present disclosure, and vice versa.

In the present specification, the term “module” includes a unit realized by hardware, a unit realized by software, and a unit realized by both the hardware and software. Further, one unit may be implemented by two or more pieces of hardware, and two or more units may be implemented by one piece of hardware.

The scope of protection of the present disclosure is not limited to the description and expression of the exemplary embodiments explicitly described above. In addition, it is stated once again that the scope of protection of the present disclosure may not be limited due to obvious changes or substitutions in the technical field to which the present disclosure pertains.

What is claimed is:

1. A data assimilation system, comprising:
an observation error data generation module that generates observation error data based on real measurement data;
a background error covariance generation module that generates background error covariance data, which is an error of a background field, based on a difference in prediction between models with different initial times for the same forecast period;
a data assimilation module that constructs a weather prediction model with data assimilation applied based on forecast result data of a pre-processed initial weather prediction model, the observation error data, and the background error covariance data; and
a lateral boundary field generation module that generates an improved lateral boundary field based on a forecast result of the initial weather prediction model and a forecast result of the weather prediction model with data assimilation applied, and applies the generated improved lateral boundary field to the weather prediction model with data assimilation applied.

2. The data assimilation system of claim 1, wherein the real measurement data includes ADP global upper air and surface weather observation data in a PreparedBUFR (PREPBUFR) format provided by national centers for environmental prediction (NCEP) and data observed by an atmospheric research aircraft, and
the data observed through the atmospheric research aircraft is dropsonde data or aircraft integrated meteorological measurement system (AIMMS-20) data.

3. The data assimilation system of claim 2, wherein the observation error data generation module extracts an observed value within a model execution period and a research area based on the ADP global upper air and surface weather observation data in the PREPBUFR format provided by the NCEP and the data observed by the atmospheric research aircraft by using OBSPROC which is a program processing an observation data in a data assimilation process.

4. The data assimilation system of claim 3, wherein the observation error data generation module converts the ADP global upper air and surface weather observation data in the PREPBUFR format provided by the NCEP and the data observed through the atmospheric research aircraft into a LITTLE_R format.

5. The data assimilation system of claim 4, wherein the observation error data generation module generates the observation error data by combining the ADP global upper air and surface weather observation data in the PREPBUFR format provided by the NCEP converted into the LITTLE_R format and the data observed through the atmospheric research aircraft.

6. The data assimilation system of claim 1, wherein the background error covariance generation module uses a control variable when generating the background error covariance data using a national meteorological center (NMC) method, and the control variable includes a variable of a global mean field (CV3).

7. The data assimilation system of claim 1, wherein the data assimilation module generates an initial field wrfinput_d01 and an initial boundary field wrfbdy_d01 based on the forecast result data of the initial weather prediction model, and changes the generated initial field wrfinput_d01 and initial boundary field wrfbdy_d01 into an initial field wrfvar_output and an initial boundary field wrfbdy to which the data assimilation is applied based on the observation error data and the background error covariance data, thereby constructing the weather prediction model with data assimilation applied.

8. The data assimilation system of claim 7, wherein the lateral boundary field generation module generates the lateral boundary field based on the initial boundary field wrfbdy_d01 of the initial weather prediction model and the initial field wrfvar_output generated through a data assimilation process.

9. A system for evaluating performance of a weather prediction model comprising:
an initial weather prediction model; and
a data assimilation system that constructs the initial weather prediction model as a weather prediction model with data assimilation applied,
wherein the data assimilation system includes:
an observation error data generation module that generates observation error data based on real measurement data;
a background error covariance generation module that generates background error covariance data, which is an error of a background field, based on a difference in prediction between models with different initial times for the same forecast period;
a data assimilation module that constructs the weather prediction model with data assimilation applied based on forecast result data of a pre-processed initial weather prediction model, the observation error data, and the background error covariance data; and
a lateral boundary field generation module that generates an improved lateral boundary field based on a forecast result of the initial weather prediction model and a forecast result of the weather prediction model with data assimilation applied, and applies the generated lateral boundary field to the weather prediction model with data assimilation applied, and
the system for evaluating performance of a weather prediction model compares the forecast result of the initial weather prediction model with the forecast results of the improved lateral boundary field and the weather prediction model with data assimilation applied to evaluate performance of the weather prediction model.

10. The system of claim 9, wherein the system for evaluating performance of a weather prediction model compares, at multiple weather observation points, meteorological variables of an experiment from the initial weather prediction model, an experiment from the weather prediction model with data assimilation applied, and a result of reanalysis data (ERA5) of ECMWF, respectively, to evaluate the performance of the weather prediction model with data assimilation applied, and
the meteorological variable includes temperature, wind speed, and relative humidity.

11. The system of claim 9, wherein the real measurement data includes ADP global upper air and surface weather observation data in a PreparedBUFR (PREPBUFR) format provided by national centers for environmental prediction (NCEP) and data observed by an atmospheric research aircraft, and
the data observed through the atmospheric research aircraft is dropsonde data or aircraft integrated meteorological measurement system (AIMMS-20) data.
